(19) United States
(12) Patent Application Publication
(10) Pub. No.: US 2026/0100093 A1
(43) Pub. Date: Apr. 9, 2026

(54) GAMING SYSTEM AND METHOD WITH OPERATOR-CONTROLLED DISPLAY OF PERSISTENCE GAME INFORMATION

(71) Applicant: Incredible Technologies, Inc., Vernon Hills, IL (US)

(72) Inventor: Jane Siegrist, Arlington Heights, IL (US)

(21) Appl. No.: 19/352,002

(22) Filed: Oct. 7, 2025

Related U.S. Application Data
(60) Provisional application No. 63/704,760, filed on Oct. 8, 2024.

(51) Int. Cl. G07F 17/32

(52) U.S. Cl. CPC G07F 17/3227; G07F 17/3213; G07F 17/3258

(57) ABSTRACT

An electronic gaming system includes a display screen and a controller. The controller is configured to permit display of: a numerical value of a persistence award and a numerical value of a player's progress toward the persistence award; a non-numerical value of the persistence award and a non-numerical value of the player's progress toward the persistence award; and no persistence award. The controller is configured to permit an operator to select whether the gaming system displays the numerical value of the persistence award and the numerical value of the player's progress toward the persistence award, and/or the non-numerical value of the persistence award and the non-numerical value of the player's progress toward the persistence award, or no persistence award. A method for providing operator control over the display of persistence game information on an electronic display screen of an electronic gaming machine is disclosed.

### CROSS-REFERENCE TO RELATED APPLICATION DATA

This application claims the benefit of and priority to Provisional U.S. Patent Application Ser. No. 63/704,760, filed Oct. 8, 2024, titled GAMING SYSTEM AND METHOD WITH OPERATOR-CONTROLLED DISPLAY OF PERSISTENCE GAME INFORMATION, the disclosure of which is incorporated herein by reference in its entirety.

### FIELD

Embodiments presented herein are directed generally to electronic gaming systems and methods, and more particularly to systems and methods providing operator-controlled display of information for persistence games played on an electronic gaming machine.

### BACKGROUND

Persistence-style gambling games are commonly known and played on electronic gaming machines. Such games can include electronic slot-type games that can provide awards or bonus games/features upon the occurrence of predetermined gaming outcomes, including the occurrence of a specified number of such predetermined outcomes. For example, when a particular outcome of a base game occurs a predetermined number of times, a true persistence game can provide a persistence award such as an award of credits or a bonus game or game feature.

In many instances, persistence games will display to a player a visual indication of the status or progress toward a persistence award on the game's main display screen and how close such an award is to occurring. Visual indication in a persistence game can commonly include a numerical count or counter of outcomes that have already occurred toward the fulfilment of designated persistence awards together with other visual indicators such as graphics of gauges, meters or other dynamic animation that can represent the proximity to such persistence awards. Persistence games can additionally display the maximum number of designated outcomes required for the generation of respective persistence awards. Such numerical designations are commonly referred to as “Must-Hit-By” values (meaning that the persistence award is awarded when the player achieves the specified number of outcomes).

FIG. 1 illustrates an example of an electronic gaming machine, showing the main display screen and the control panel display screen. FIG. 2 illustrates the display screen that presents representative persistence game information in the nature of “Must-Hit-By” values, numerical counts and graphics for various persistence awards (designated as MEGA, GRAND, MAJOR, MINOR and MINI).

FIG. 3 is a side-by-side view of a main display screen (such as that in FIG. 2) for an electronic gaming machine and a control panel display screen with persistence information displayed thereon. As shown in FIG. 3, the control panel display screen can visually present quantitative persistence information relative to various wager amounts and denominations for each persistence award. As shown, the persistence information can include the number of outcomes that have been achieved relative to a persistence award, as well as the number of outcomes needed to achieve the persistence award.

The display of persistence information is intended to attract players to play particular games and to excite, motivate or encourage players to continue playing the game by communicating that progress is being made toward the occurrence of a particular bonus award or that an award is imminent. Upon the occurrence of the persistence award, the persistence counter and associated information will typically reset to a default value, and the game will begin retracking toward the next persistence award.

Although the visual display of the persistence game status information or “Must-Hit-By” values can contribute to a player's excitement and interest in the game, it can also unfortunately encourage or attract “advantage players” or vultures. These players may stalk the game and players, and interfere with or harass the player into discontinuing play of the game where the occurrence of a persistence award is imminent. Such conduct can lead to negative experiences about gaming or a particular casino which can be harmful to the gaming industry or a particular casino's gaming revenue or image/reputation.

Accordingly, and in view of the competing advantages and disadvantages associated with the display of persistence game information, there is a need for providing casino operators with the ability to control the visual presentation of persistence game information on gaming machines. Desirably, such a system and method permit casino operators to display all or some of the persistence game information when it can be helpful and advantageous, and to conceal all or some of the persistence game information when it is advantageous to conceal such information.

Desirably, such a system and method permit operators to control gaming machines to conceal quantitative and/or qualitative persistence game information, including explicit numerical progress toward the persistence awards on the electronic game display which can make such information less conspicuous to advantage players and mitigate unsavory conduct.

### SUMMARY

This control of persistence information includes the ability to display or conceal all of the information and display or conceal a portion of the information as desired. Such a system and method permit casino operators to display all or some of the persistence game information when it can be helpful and advantageous, and to conceal all or some of the persistence game information when it is advantageous to do so.

In one aspect, an electronic gaming system includes a display screen and a controller. The controller is configured to permit display of a numerical value of a persistence award and a numerical value of a player's progress toward the persistence award, a non-numerical value of the persistence award and a non-numerical value of the player's progress toward the persistence award and no persistence award.

The controller is configured to permit an operator to select whether the gaming system displays the numerical value of the persistence award and the numerical value of the player's progress toward the persistence award and/or the non-numerical value of the persistence award and the non-numerical value of the player's progress toward the persistence award or no persistence award.

In embodiments, the controller is configured to permit an operator to select the display of both the numerical value of the persistence award and the numerical value of the player's progress toward the persistence award and the non-numerical value of the persistence award and the non-numerical value of the player's progress toward the persistence award.

The controller can be configured to permit display of a perceived persistence award, and can be configured to permit display of the perceived persistence award when the operator selects display of no persistence award. In embodiments, the perceived persistence award is an animation.

The non-numerical value of the player's progress toward the persistence award can be displayed as an animation. In an embodiment, the animation is a columnar display. The persistence award can be displayed as a height of the columnar display.

In embodiments, the animation is a collection of items, and the player's progress toward the persistence award is displayed as, for example, an increase in a collection of items.

In an aspect, the electronic gaming system can include multiple persistence awards, and the controller can be configured to permit display of, concurrently, the numerical value of each persistence award and the numerical value of the player's progress toward each persistence award, and/or the non-numerical value of each persistence award and the non-numerical value of the player's progress toward each persistence award, or no persistence award.

In such a system, the controller is configured to permit an operator to select whether the gaming system displays, concurrently, the numerical value of each persistence award and the numerical value of the player's progress toward each persistence award, and/or the non-numerical value of each persistence award and the non-numerical value of the player's progress toward each persistence award, or no persistence award.

In still another aspect, a method for providing operator control over the display of persistence game information on an electronic display screen of an electronic gaming machine, which electronic gaming machine has a controller, includes configuring the controller to permit display of a numerical value of a persistence award and a numerical value of a player's progress toward the persistence award, and/or a non-numerical value of the persistence award and a non-numerical value of the player's progress toward the persistence award, or no persistence award.

The method further includes permitting the operator, through restricted access, to select whether the gaming system displays the numerical value of the persistence award and the numerical value of the player's progress toward the persistence award, and/or the non-numerical value of the persistence award and the non-numerical value of the player's progress toward the persistence award, or no persistence award.

Methods can further include configuring the controller to permit the operator to select the display of both the numerical value of the persistence award and the numerical value of the player's progress toward the persistence award and the non-numerical value of the persistence award and the non-numerical value of the player's progress toward the persistence award.

Further methods can include configuring the controller to conceal the persistence value and the player's progress toward the persistence value, and permit display of a perceived persistence award. In such a method, the controller can be configured to permit display of the perceived persistence award when the operator selects display of no persistence award. The perceived persistence award can be an animation.

In methods, the non-numerical value of the player's progress toward the persistence award is displayed as an animation. Animations can be a columnar display. The non-numerical value of the player's progress toward the persistence award can be displayed as a height of the columnar display.

In methods, the animation can be a collection of items and the player's progress toward the persistence award is displayed as an increase in the collection of items.

In still another aspect, the method for providing operator control includes multiple persistence awards, and the controller is configured to display, concurrently, the numerical value of each persistence award and the numerical value of the player's progress toward each persistence award, and/or non-numerical value of each persistence award and the non-numerical value of the player's progress toward each persistence award, or no persistence award.

In such methods, the controller is configured to permit an operator to select whether the gaming system displays concurrently the numerical value of each persistence award and the numerical value of the player's progress toward each persistence award, and/or the non-numerical value of each persistence award and the non-numerical value of the player's progress toward each persistence award or no persistence award.

These and other objects, features and advantages of the present disclosure will be apparent from the following detailed description taken in conjunction with the accompanying drawings, and in conjunction with the appended claims.

### DESCRIPTION OF THE DRAWINGS

The benefits and advantages of the present disclosure will become more readily apparent to those of ordinary skill in the relevant art after revieing the following detailed description and accompanying drawings, in which:

FIG. 1 illustrates an example of an electronic gaming machine;

FIG. 2 illustrates a display screen of an example of an electronic gaming system showing representative persistence game information in the nature of “Must-Hit-By” Values;

FIG. 3 is a side-by-side view of a main display screen for an electronic gaming machine and a control panel display screen with persistence information displayed thereon;

FIG. 4 illustrates the display of FIG. 2 with persistence information partially concealed in accordance with embodiments of the present disclosure;

FIG. 5 is a side-by-side view of the displays of FIG. 3 with the persistence information partially concealed in accordance with embodiments of the present disclosure;

FIG. 6 is an example of another main display screen with concealment turned fully off, that is with the numerical value of each persistence award and the numerical value of the game's progress toward each persistence award shown;

FIG. 7 illustrates the main display screen of FIG. 6 with partial concealment, that is with the non-numerical value of each persistence award and the non-numerical value of the game's progress toward each persistence award shown;

FIG. 8 illustrates the main display screen of FIG. 6 with full concealment, that is neither the numerical nor non-numerical values of the persistence award, nor the game's progress toward each persistence award (no persistence award information shown);

FIG. 9 is a view of a representative configuration screen which can enable an operator to enable or disable the concealment feature in accordance with embodiments presented herein;

FIG. 10 is a view of another representative configuration screen to enable an operator to enable or disable the concealment feature; and

FIG. 11 is a view of another example of a representative configuration screen to enable an operator to enable or disable the concealment feature.

### DETAILED DESCRIPTION

While elements disclosed herein are susceptible of embodiment in many different forms, there are shown in the drawings, and will be described herein in specific detail, representative embodiments thereof with the understanding that the present disclosure is to be considered as an exemplification of the principles of the present disclosure and is not intended to be limited to the specific embodiments illustrated.

Embodiments presented herein are directed to gaming machines, systems, devices and methods that can provide operator-controlled features for the visual display or concealment of quantitative information and/or metrics/data for persistence game awards. Such embodiments can enable an operator to conceal visual indicators that display to a player particular quantitative and/or graphical information as to the occurrence of a bonus or supplemental award event that occurs after a particular number of outcomes is achieved in a true persistence game.

According to exemplary embodiments, the selectable display feature can enable a casino operator to turn-off or configure the game to not display a numerical game count or counter that identifies the quantitative status toward a persistence game bonus award, and to turn-off or configure the game to not display graphical indicators that identifies the qualitative status of progress toward a persistence game bonus award.

Further embodiments disclosed herein enable an operator to display perceived persistence levels by, for example, a display of coins, bags of coins, tokens, or other animations when, for example, all true persistence levels and achievement toward persistence levels are concealed.

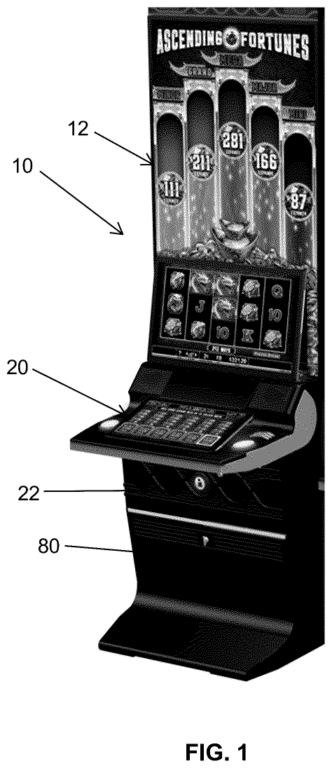

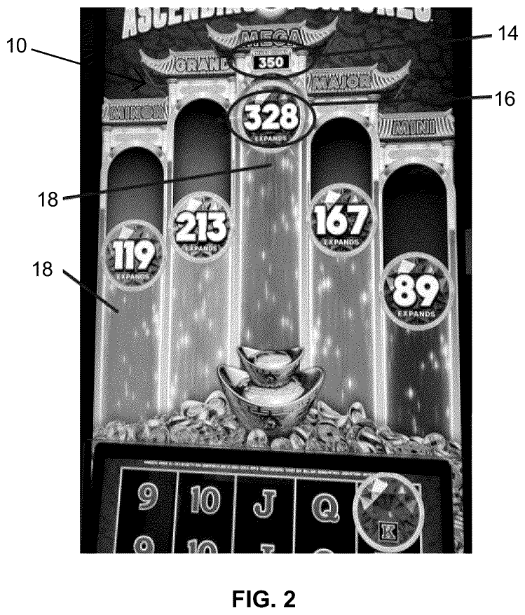

FIG. 1 illustrates one example of an electronic gaming machine 10. FIG. 2 illustrates the main display screen 12 of the example gaming machine 10. The display screen 12 shows representative persistence game information in the nature of “Must-Hit-By” values 14. Progress values 16 as well as a representative bar graphics or meters 18 are shown for the game's progress toward a persistence award 14. In FIG. 2, the “Must-Hit-By” value 14, or award level shown for a MEGA award is 350 and the persistence level, indicated at 16, attained by the player(s) is 328. Likewise for the GRAND, MAJOR, MINOR and MINI “Must-Hit-By” values or award levels, and the persistence levels attained by the player(s) are 213, 167, 119 and 89, respectively. It will be understood that the various “Must-Hit-By” value or award names and levels may vary among the different games, casinos and the like.

It will be appreciated that the “Must-Hit-By” values 14, and the persistence levels attained by the player(s) 16 can also be displayed on the control screen 20 in addition to the being displayed on the main display screen 12.

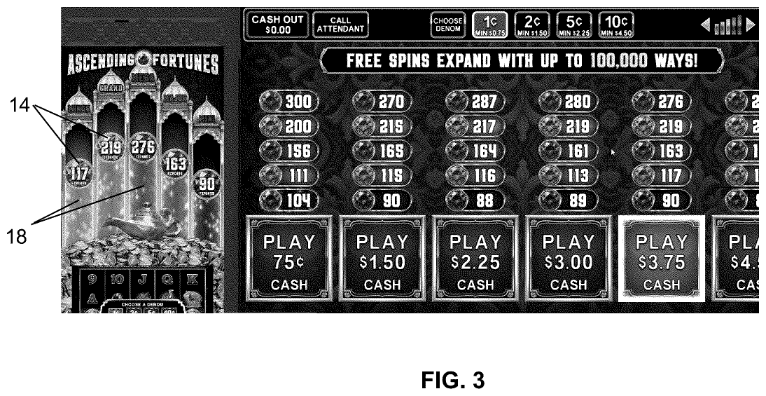

FIG. 3 illustrates a side-by-side view of the main display screen 12 of electronic gaming machine 10 and the control panel display screen 20 with quantitative persistence information 14, 16 displayed on both the control panel display screen 20 and the main display screen 12. The control panel display screen 20 is the player's main startup screen for selecting plays, values to play (e.g., the value played per spin) and the like.

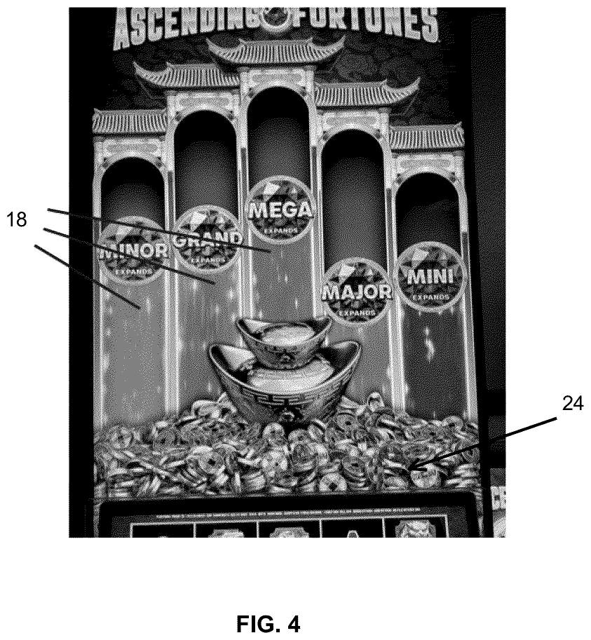

Referring to FIG. 4, in an embodiment of the present system to provide operator-controlled display of information for persistence games, the quantitative persistence information 14, 16 (as seen in FIG. 2) is partially concealed. That is, the quantitative/numerical “Must-Hit-By” values are hidden and not presented to the player. Rather, graphical representations depicting progress toward the award level is shown by the bar graphic or meter 18. As such, as the game progresses toward the “Must-Hit-By” value, the bar graphic or meter 18 will rise to graphically indicate the game's progress, but the corresponding specific persistence numerical value 16 and the “Must-Hit-By” numerical value 14 are concealed. It will be appreciated the present system and method permit an operator to display or conceal either or both of persistence numerical values 16 and the “Must-Hit-By” numerical value 14.

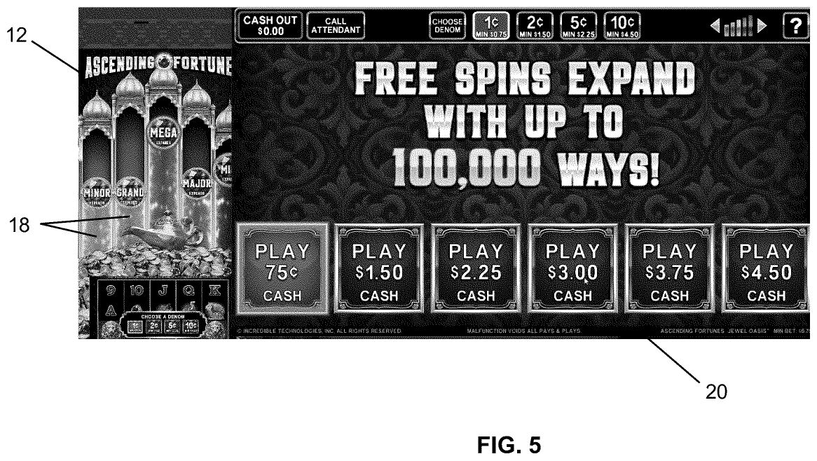

FIG. 5 is a side-by-side view of displays 12, 20 of FIG. 3 and is similar to FIG. 3, except that in this view, the quantitative persistence information 14, 16 is concealed on the main display screen 12 and the control panel display screen 20 in accordance with embodiments presented herein (with the graphical depictions continuing to be displayed on the main display screen 12). As shown in FIG. 5, the “Must-Hit-By” 14 value, and other quantitative/numerical information relative to the persistence awards is hidden and not presented.

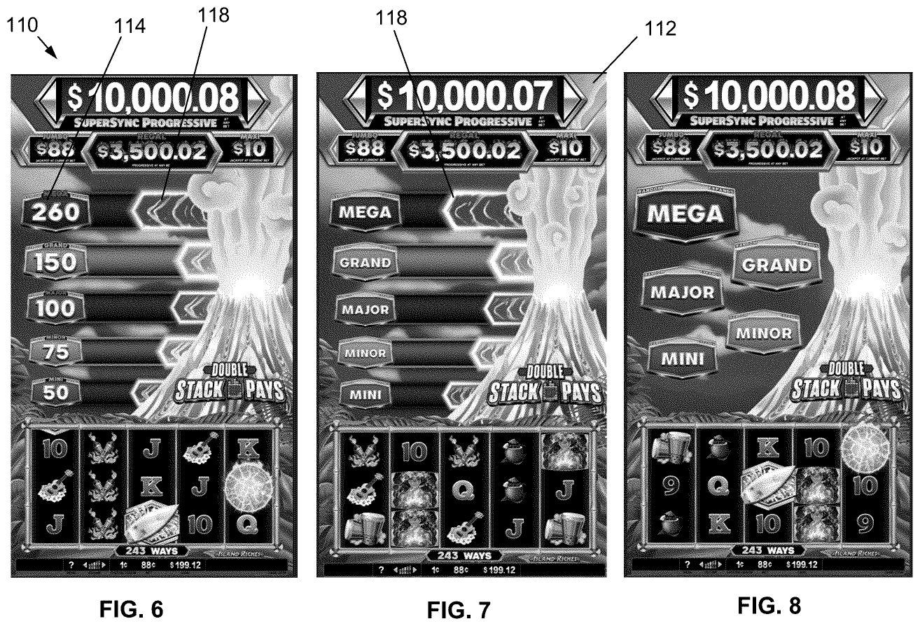

FIGS. 6-8 illustrate an example of another electronic gaming machine main display screen 112 for a game machine 110 providing the persistence concealment feature. FIG. 6 illustrates the main display screen 112 with concealment turned fully off, that is with the numerical value of each persistence award 114 (that is the “MUST-HIT-BY”) value and a bar graphic 118 of the player's progress toward each persistence award shown. FIG. 7 shows the display screen with partial concealment, that is with the numerical value of each persistence award concealed and with the non-numerical value (i.e., the graphical representation) of the game's progress 118 toward each persistence award shown by a bar graphic. And FIG. 8 illustrates the display screen with full concealment, that is neither the numerical values nor non-numerical graphical representations of the persistence award, nor the game's progress toward each persistence award (no persistence award information shown). According to example embodiments, a game with true persistence information fully concealed as shown in FIG. 8, can display graphics and/or animations in the nature of perceived persistence visualizations. Such perceived persistence information can include, for example, flames around particular persistence awards to give the perception that progress toward such persistence award has been made or that such persistence award is close to being awarded.

Although the game (game controller 22) can maintain a quantitative count for awarding persistence awards, when the operator enables the concealment feature, quantitative information in the nature of “Must-Hit-By” values or specific numbers/counts of occurrences (or remaining outcomes) toward a persistence award can be concealed or masked from electronic game displays, and thus the players. The game can be configured such that concealment feature can enable the main display to present other visual indicators in the nature of graphics or animations (gauges/status bars/other symbolism) that generally track and show advancement toward the persistence bonus award. It will be recognized that such graphical representations can indicate the next occurrence of persistence awards more symbolically or abstractly and do not identify a specific numerical indication or quantitative value. As such, the game can forego displaying direct values or numerical information to advantage players which reflect the precise metrics for the achievement of particular persistence awards. This furthers the desire to make such information less conspicuous and thus dissuade advantage players and mitigate unsavory conduct.

As noted above, the concealment feature can be configured to be operator-controlled and can be disabled to permit the game to display numerical information regarding persistence bonus awards should an operator find it advantageous.

In embodiments, there can be multiple modes of display, including display of: numerical values of persistence awards and numerical values of progress toward persistence awards; numerical values of persistence awards and non-numerical graphical representations depicting progress toward persistence awards; non-numerical graphical representations of persistence awards and non-numerical graphical representations of progress toward persistence awards; and full concealment of persistence awards and progress toward persistence awards. Such non-numerical graphical representations can be, for example, visual indicators in the nature of graphics or animations, such as gauges, status bars, coins, bags of coins, tokens, and/or other symbolism.

It will be appreciated that when in the full concealment mode, that is, when all persistence levels and achievement toward persistence levels are concealed, the system can be configured to permit an operator to display perceived persistence levels by, for example, a display of coins, bags of coins, tokens, or other animations (an example of which is shown at 24 in FIG. 4).

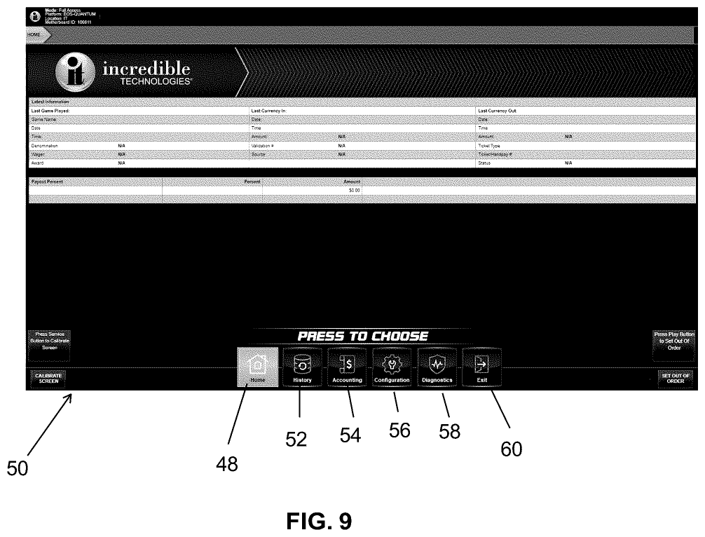

FIGS. 9-11 are views of representative configuration screens which can enable an operator (that is an authorized operator or technician, and not a player) to enable or disable the concealment feature in accordance with embodiments presented herein.

FIG. 9 is an example of a precursor screen 50 showing various tiles for control options for the operator to obtain machine history 52, accounting 54, view or change machine configuration 56, obtain or run diagnostics 58 and exit 60 the screen, and to return to a home screen 48.

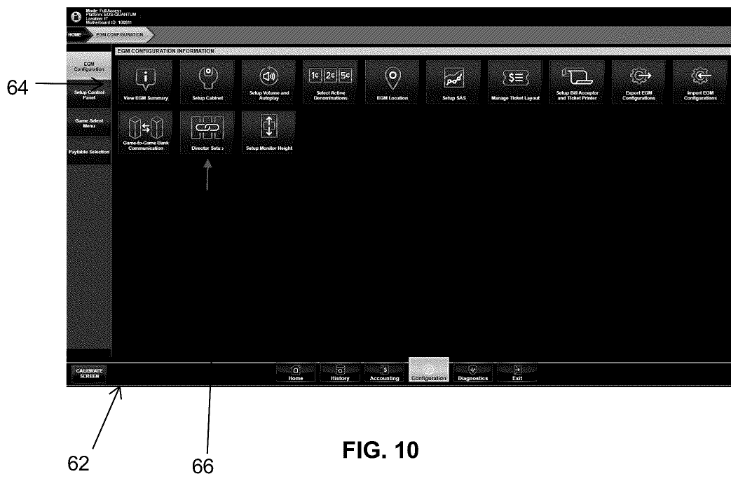

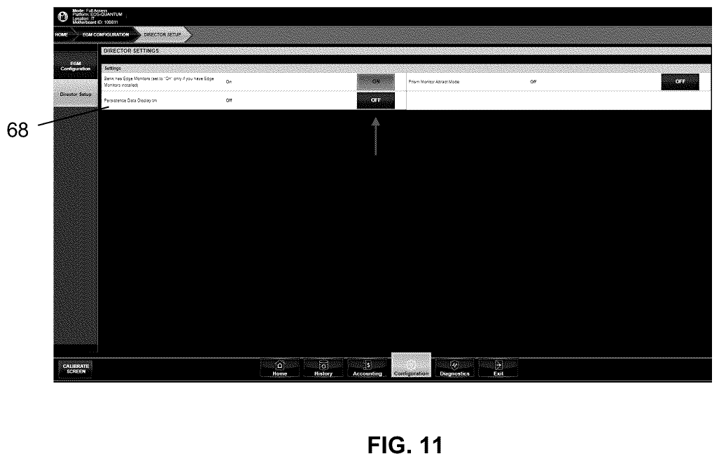

FIG. 10 illustrates a configuration sub-screen 62 having various tiles 64 that permit an operator to configure various settings for the machine, including the concealment feature, in this instance through the Director Setup tile 66. And FIG. 11 illustrates a screen in which the operator can select to display or conceal the persistence data by toggling the Persistence Data Display tile 68. It will be understood that although a single selection is shown for the operator to toggle Persistence Data Display on and off, the selection(s) for concealment or display can vary, including what is displayed, including numerical values and/or graphical indicators for the “Must-Hit-By” value and the game's progress toward that value, and the location of display, including on the control panel display screen and the main display screen.

It will also be appreciated that such configuration screens are restricted access, and can be accessed directly at an electronic gaming machine unit by an authorized technician, for example, with an access key to open a door 80 on the machine or remotely by a central game controller. Thus, the concealment feature can be enabled/disabled/modified for a specific gaming machine or a bank or plurality of gaming machines across a casino floor or at multiple different casinos. The enablement/disablement of the concealment feature can be software implemented by computer code in the nature of a logic tree whereby designated values are associated with enabling the concealment feature, either partially or fully, and another designated value is associated with disabling the concealment feature. Upon the selection of a designated value to enable the concealment feature, the game controller can transmit instructions to the display screen to bypass predetermined persistence information. Accordingly, by way of example a first designated value for enablement of the concealment feature can be associated with instructions to bypass quantitative/numerical values associated with persistence prizes, and a second designated value can be associated with instructions to bypass graphical representations indicating progress toward persistence awards. Other designated values can be associated with instructions to display perceived persistence visualizations. Thus, the concealment features can be operator configurable settings that can be selectively toggled by the operator between an active state and an inactive state as desired.

It is understood that the features from any of the embodiments described herein may be combined with, or replace features of other embodiments described herein, without deviating from the scope of this disclosure.

In the present disclosure, the words “a” or “an” are to be taken to include both the singular and the plural. Conversely, any reference to plural items shall, where appropriate, include the singular.

All patents referred to herein are hereby incorporated herein by reference, whether or not specifically done so within the text of this disclosure.

Further, any logic flows depicted in the figures do not require the particular order shown, or sequential order, to achieve desirable results. Other steps may be provided, or steps may be eliminated, from the described flows, and other components may be added to, or removed from the described embodiments.

From the foregoing, it will be observed that numerous variations and modifications may be affected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. An electronic gaming system, comprising:
a display screen; and
a controller, the controller configured to permit display of: a first numerical value of a persistence award and a second numerical value of progress toward the persistence award; a first non-numerical graphical depiction of the persistence award and a second non-numerical graphical depiction of progress toward the persistence award; and a full concealment condition comprising no display of the first and second numerical values and the second non-numerical graphical depiction for the persistence award,
wherein the controller is configured to permit an operator by manual selection to control the gaming system to display at least one of: the first numerical value and the second numerical value; the first non-numerical graphical depiction and the second non-numerical graphical depiction, and the full concealment condition.

2. The electronic gaming system of claim 1, wherein the controller is configured to permit an operator to select the display of both the first and second numerical values and the first and second non-numerical graphical depictions.

3. The electronic gaming system of claim 1, wherein the controller is further configured to permit display of a perceived persistence graphic.

4. The electronic gaming system of claim 3, wherein the controller is configured to permit display of the perceived persistence graphic when the operator selects display of the full concealment condition.

5. The electronic gaming system of claim 3, wherein the perceived persistence graphic is an animation.

6. The electronic gaming system of claim 1, wherein the second non-numerical graphical depiction of progress toward the persistence award is displayed as an animation.

7. The electronic gaming system of claim 6, wherein the animation is a columnar display.

8. The electronic gaming system of claim 7, wherein the second non-numerical graphical depiction of progress toward the persistence award is displayed as a length of the columnar display.

9. The electronic gaming system of claim 6, wherein the animation is a collection of items, and wherein the player's progress toward the persistence award is displayed as an increase in the collection of items.

10. The electronic gaming system of claim 1, including multiple persistence awards, wherein the controller is configured to permit concurrent display of at least one of, the first numerical value of each persistence award and the second numerical value of progress toward each persistence award; and the non-numerical graphical depiction of each persistence award and the non-numerical graphical depiction of progress toward each persistence award; and the full concealment condition for each persistence award, and
wherein the controller is configured to permit an operator by manual selection to control the gaming system to display concurrently, the first numerical value of each persistence award and the second numerical value of progress toward each persistence award; the non-numerical graphical depiction of each persistence award and the non-numerical graphical depiction of progress toward each persistence award, and the full concealment condition for each persistence award.

11. A method for providing operator control over a display of persistence game information on an electronic display screen of an electronic gaming machine, the electronic gaming machine having a controller, the method comprising:
configuring the controller to permit display of: a first numerical value of a persistence award and a second numerical value of progress toward the persistence award; a first non-numerical graphical depiction of the persistence award and a second non-numerical graphical depiction of progress toward the persistence award; and no persistence award; and
permitting the operator, through restricted access, to select whether the gaming system displays: the numerical value of the persistence award and the numerical value of the player's progress toward the persistence award; and/or the non-numerical value of the persistence award and the non-numerical value of the player's progress toward the persistence award; a full concealment condition comprising no display of the first and second numerical values and the second non-numerical graphical depiction for the persistence award.

12. The method for providing operator control of claim 11 further comprising configuring the controller to permit the operator to select the display of both the first and second numerical values and the first and second non-numerical graphical depictions.

13. The method for providing operator control of claim 11 further comprising configuring the controller to permit display of a perceived persistence graphic.

14. The method for providing operator control of claim 13 further comprising configuring the controller to permit display of the perceived persistence graphic when the operator selects display of the full concealment condition.

15. The method for providing operator control of claim 13, wherein the perceived persistence graphic is an animation.

16. The method for providing operator control of claim 11, wherein the second non-numerical graphical depiction of progress toward the persistence award is displayed as an animation.

17. The method for providing operator control of claim 16, wherein the animation is a columnar display.

18. The method for providing operator control of claim 17, wherein the second non-numerical graphical depiction of the player's progress toward the persistence award is displayed as a length of the columnar display.

19. The method for providing operator control of claim 16, wherein the animation is a collection of items, and wherein the progress toward the persistence award is displayed as an increase in the collection of items.

20. The method for providing operator control of claim 11, including multiple persistence awards, wherein the controller is configured to concurrently display at least one of, the first numerical value of each persistence award and the second numerical value of progress toward each persistence award; the first non-numerical graphical depiction of each persistence award and the second non-numerical graphical depiction of the progress toward each persistence award; and the full concealment condition for each persistence award, and
wherein the controller is configured to permit an operator by manual selection to control the gaming system to concurrently display the first numerical value of each persistence award and the second numerical value of progress toward each persistence award; the first non-numerical graphical depiction of each persistence award and the second non-numerical depiction of the player's progress toward each persistence award; and the full concealment condition for each persistence award.
